(19) United States
(12) Patent Application Publication
(10) Pub. No.: US 2006/0223541 A1
(43) Pub. Date: Oct. 5, 2006

(54) Use of multiple wireless interfaces in wireless networks

(75) Inventor: David Famolari, Stewartsville, NJ (US)

Correspondence Address: BANNER & WITCOFF, 1001 G STREET N W, SUITE 1100, WASHINGTON, DC, 20001, US

(73) Assignees: Toshiba America Research Inc., Piscataway, NJ (US); Telcordia Technologies, Piscataway, NJ (US)

(21) Appl. No.: 11/098,515

(22) Filed: Apr. 5, 2005

(51) Int. Cl. H04Q 7/20

(52) U.S. Cl. 455/450; 455/453

(57) ABSTRACT

A system and method for transmitting data over a plurality of channels is described. The system determines a clear channel and transmits data over that channel. In some examples, the data is formatted prior to identification of the clear channel. In other examples, the data is formatted after identification of the clear channel.

### BACKGROUND OF THE INVENTION

1. Field of the Invention

Aspects of the present invention relate to wireless communication systems. More particularly, aspects of the present invention relate to channel selection for wireless communication systems.

2. Description of Related Art

Wireless networking protocols generally have one or more channels. Wireless networking devices typically have a single radio interface that allows the devices to monitor one and only one radio channel at a time. Other wireless networking devices have multiple interfaces that permit selection of a channel. However, once a channel has been set, networking devices having multiple interfaces are relegated to using that channel for the rest of a session. In other words, all traffic flow must traverse one and only one network interface. This use of a single channel leads to inefficiencies when sending packet data, particularly when dynamic network conditions temporarily favor one interface. Current devices are unable to take advantage of these temporal advantages.

Typical approaches to increase effectiveness through multiple channels deals with initial channel acquisition and association. For example, such approaches attempt to optimize the assignment of terminals to radio channels to equitably balance the load. These approaches still leave terminals sending data one a single radio access channel. Other approaches rely on using a “signaling” channel in parallel to a “data” channel. The signaling channel coordinates with other nodes in the network to agree upon acceptable radio access channels over which to send data. These approaches require collaboration among terminals to settle on when to use certain channels.

The channel assignment approach fails to take advantage of the dynamism present in wireless networks where channel conditions can change on the order of milliseconds. The conventional approaches still lead to inefficiencies and wasted bandwidth. The signaling channel approach requires that two or more stations collaborate on the choice of channel and thus stations cannot act unilaterally. Also, this type of collaboration represents an overhead that taxes network performance.

An improved approach is needed that can realize network channel efficiencies when present.

### BRIEF SUMMARY OF THE INVENTION

Aspects of the invention address one or more problems described above, thereby providing improved network performance. Aspects of the invention permit monitoring and operating multiple radio access channels to route packets using available channels.

### BRIEF DESCRIPTION OF THE DRAWINGS

Aspects of the present invention are illustrated by way of example and not limited in the accompanying figures in which like reference numerals indicate similar elements.

FIG. 1 shows a mobile terminal communicating with an access point in accordance with aspects of the present invention.

FIG. 2 shows a mobile terminal communicating with two access points in accordance with aspects of the present invention.

FIG. 3 shows a process for channel selection in accordance with aspects of the present invention.

FIG. 4 shows a data structure associated with a transmitting device in accordance with aspects of the present invention.

FIG. 5 shows a system for selecting a channel in accordance with aspects of the present invention.

FIG. 6 shows an alternate system for selecting a channel in accordance with aspects of the present invention.

FIG. 7 shows another alternate system for selecting a channel in accordance with aspects of the present invention.

### DETAILED DESCRIPTION OF THE INVENTION

Aspects of the present invention relate to systems and methods that monitor and transmit on multiple channels according to network usage. By using one or more of the approaches described below, network handling of packets may be improved. For instance, at least one of packet throughput and packet delay may be improved.

It is noted that various connections are set forth between elements in the following description. It is noted that these connections in general and, unless specified otherwise, may be direct or indirect and that this specification is not intended to be limiting in this respect.

To assist the reader, the following is divided into the following sections: channel selection and use; selection before assembly; assemble before selection; and assemble before selection using available channels.

Channel Selection and Use

Aspects of the present invention relate to empowering transmitting stations (mobile terminals or access points) to determine and use a channel as needed. Instead of restricting a transmitting station to only a single channel for its session, aspects of the present invention permit a terminal to take advantage of available radio channels and interfaces to improve network performance by increasing throughput and reducing packet delay. It is estimated that improvements may exceed 25%.

Conventional wireless local area network devices are designed to monitor one and only one radio access channel at a time whether or not they are equipped with one or more radio interfaces. That is, these devices must initially decide upon a single radio access channel before beginning transmission and maintain that association throughout the lifetime of their data sessions. This mapping of a wireless device to a single radio access channel leads to inefficiencies and opportunity costs since dynamic network conditions can temporarily favor one radio access channel over another. In particular, the better radio access channel at any given interval may not be the one on which the wireless device is using. Current approaches do not fully exploit these temporal advantages.

Aspects of the present invention include terminals that monitor multiple radio channels and send packets on the next available channel. Where receivers monitor multiple channels, the selection of any given channel for transmission requires no collaboration with other terminals and allows the terminal to opportunistically leverage transmission opportunities.

In some aspects of the present invention, at least one of the following may be achieved: increased throughput, reduced delay, reduced interference in a network, reduced wasted bandwidth, can be performed locally, and load-balancing traffic across available channels. In particular, any given packet may experience a reduced amount of time waiting for a clear channel.

The following lists projected estimates of improved waiting times for a number of packets using a specified number of channels:

1) 30% savings in packet waiting time for two 802.11b channels

2) 24% savings in packet waiting time for two 802.11a channels

3) 45% saving in packet waiting time for three 802.11b channels

4) 36% savings in packet waiting time for three 802.11a channels

Aspects of the present invention follow CSMA procedures governing single channel access. In a first example of the invention, a transmitting station or terminal picks a channel, transmits on the channel, and receives an acknowledgement from a receiving station or terminal on the same channel. In a second example of the invention, the transmitting station or terminal picks a first channel, transmits on the first channel, and receives the acknowledgement from the receiving station or terminal on a second channel.

Aspects of the present invention may be used with various radio technologies, thereby allowing a terminal to use channels available in the 802.11a, 802.11b, and 802.11g networks. This allows the terminal to take full advantage of the entire set of available radio access channels regardless with which particular radio access technology the terminal is associated.

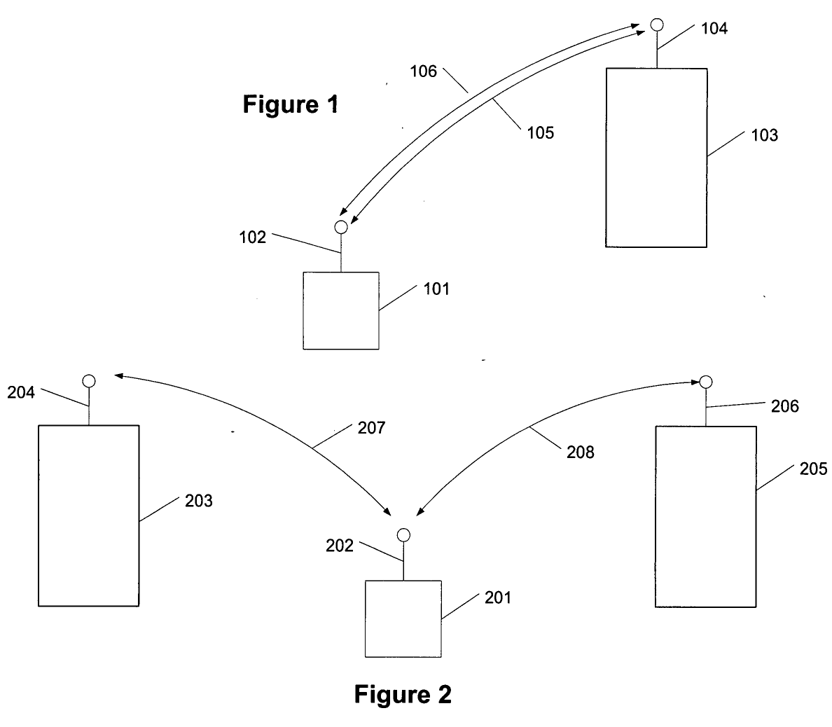

FIG. 1 shows a terminal 101 and antenna 102 and access point 103 and antenna 104, in which multiple channels are used to exchange packets between them. The terminal 101 is monitoring multiple interfaces. Here, the terminal 101 and the access point 103 exchange a first packet on a first channel 105 and exchange a second packet on second channel 106.

FIG. 2 shows a terminal 201 and antennal 202 communicating with two access points, access point 203 and antenna 204 and access point 205 and antenna 206. Here, the terminal transmits a first packet to access point 203 using a first channel 207 and transmits a second packet to access point 205 using a second channel 208.

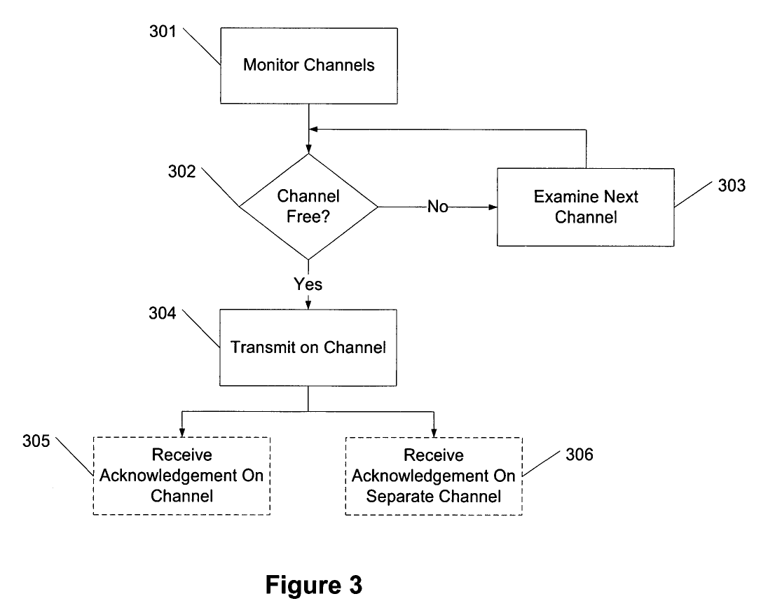

FIG. 3 shows an illustrative example of a process for selecting and transmitting on a channel. Here, a terminal has access to a number of different radio access channels and is capable of independently monitoring them through the traditional Carrier Sensing (CS) mechanism. This is shown in step 301. The CS process detects radio energy present in the channel. The number of channels monitored by the terminal may span frequency bands and radio access technologies such as 802.11a, 802.11b and 802.11g. The number of channels that may be monitored is limited by the number of simultaneous CS mechanisms the terminal is capable of maintaining and by the number of non-overlapping radio access channels that are present. While the invention is not limited by this restriction, it is desirable that the terminal only monitor non-overlapping frequency channels to reduce the amount of interference.

In step 302, the system determines whether a channel is free. If no, then the system examines the next channel in step 303. If yes, then the system transmits on that channel in step 304. The transmitting terminal may receive an acknowledgement on the same channel as shown in step 305 or may receive the acknowledgement on a separate channel as shown in step 306.

The assessment of whether a channel is clear may be based on the MAC layer of 802.11. Other protocols that use or have yet to be created that have a MAC layer may be used in conjunction with aspects of the present invention. The assessment may be based solely on the traffic of the channel. Alternatively, the assessment may be based on the traffic in a channel and on one or more criteria. An illustrative example of the criteria may include a received signal power.

Furthermore, the terminal may be able to maintain independent Carrier Sensing Multiple Access with Collision Avoidance (CSMA/CA) MAC protocol states for each of the monitored channels. This CSMA/CA MAC protocol is detailed in the industry standards that govern the operation of 802.11a, 802.11b and 802.11g. For the purposes of this invention, these MAC procedures can be encapsulated in a single parameter called the Clear Channel Assessment, or CCA. The CCA indicates whether or not the particular radio access channel is clear for transmission. The CCA indicates a clear channel only when the CSMA/CA MAC protocol requirements for transmission have been satisfied. This may be implemented by monitoring a backoff timer value as well.

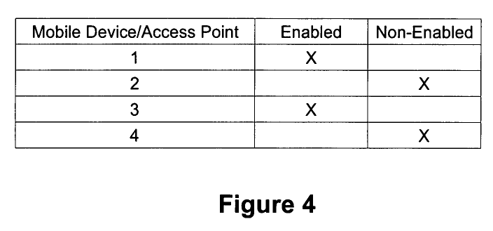

It is appreciated that not all devices (mobile device and terminal) may have the capabilities of monitoring multiple channels. Enabled devices may desire to keep track of the other devices (mobile or terminal) with which it has contact. FIG. 4 shows an illustrative example of a table that lists devices having had contact with the current device. The current device may keep track of which other devices are enabled to monitor and respond on multiple channels and which other devices are not. The information shown in FIG. 4 may be kept in each device, in an access point, in a mobile terminal, in a centralized location, or any combination thereof.

Two general representations of aspects of the invention are described below. A third general representation that is a partial combination of the first two general representations is also shown.

Selection Before Assembly

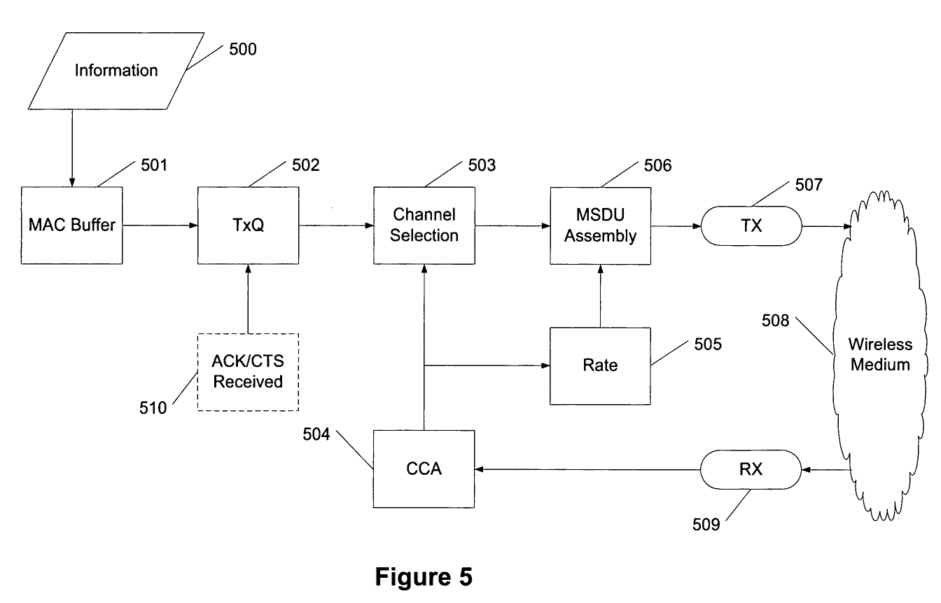

FIG. 5 shows a first general representation of aspects of the invention. The process described herein may be realized with standard processors and memory associated with wireless devices.

A MAC buffer 501 receives information 500 to be transmitted and forwards a packet to transmission queue (TxQ) 502 where the packet awaits transmission. MAC buffer 501 may hold one or more packets from higher layer applications.

Next, in step 503, the system selects a free channel. In step 506, the system assembles MSDUs. MSDUs are MAC services data units. MSDUs are data packets properly formatted for transmission. They are formatted according to the particular modulation schemes and transmission rates associated with the radio access channel and include radio access channel specific values in their header fields. Accordingly, identical data packets may have different MSDU representations depending upon the radio access channel on which they are transmitted.

In step 507, the MSDUs are transmitted through wireless medium 508 to a receiver (not shown). Packets are received from wireless medium through receiver 509. Information from the received packets is used to assess whether or not the channel is being used by a clear channel assessment indicator 504. The output from the CCA indicator 504 is used in the channel selection step 503 and the determination of what rate to use in step 505 for transmission on a channel. The selected rate from step 505 is fed into the MSDU assembly step 506.

There are two variations of transmission: the basic transmission method (data/data acknowledgement and the RTS/CTS methods. First, in the basic transmission method, data is transmitted on a clear channel. An acknowledgement is received in response to the transmission of the data.

Second, the RTS/CTS method of operation is a slight modification of the basic transmission procedure. The CSMA/CA standard defines the optional use of Request-to-Send and Clear-to-Send packets to help govern medium access on the channel. The RTS packet contains a request to the destination station. If the destination accepts the request, it will respond with a CTS packet that indicates the sender is free to transmit the packet. Both the RTS and CTS packets contain a Duration field that contains a number representing the anticipated time that the medium will be occupied by the data packet transmission. This allows other stations that are monitoring the channel to know how long the transmission will take so that they can refrain from transmitting for that time. Stations within radio range of the sender receive and process the duration field contained in the RTS packet, while stations within radio range of the destination receive and process the duration field contained in the CTS packet. Stations within radio range of both the sender and the destination receive and process both duration fields. This method ensures that all terminals within radio range of either the sender or the destination are aware of the pending transmission and thus reduces interference. Since the Duration field is a relevant parameter associated with the pending data packet, both the data packet and the RTS packet can be sent on the same radio access channel. Alternatively, a separate channel for the data packet different from the channel for the RTS packet may be used. One of the benefits of using a channel for the RTS and data transmissions is the ability to coordinate on the channel to be used. If another system does not receive, for instance, one of the RTS or CTS packets and it is planning on using the data channel, it will see an open data channel while the original transmitting and receiving stations are intending to use the channel. One of the benefits of using different channels is the possibility of greater throughput on the data channel. By having transmitters and receivers coordinate on a second channel, the data channel may be fully used.

The basic transmission method is described below. A description using the RTS/CTS method is described later. In the basic transmission method, the TxQ 502 monitors all of the CCA values from CCA 504 associated with each of the radio access channels that the terminal is monitoring. The packet in the TxQ 502 is transmitted on the radio access channel associated with the first (or other) CCA indicating a clear channel. If more than one CCA indicates a clear channel at the same time, the terminal may select the radio access channel with the fastest possible transmission rate. If more than one such radio access channel possesses the same maximum transmission rate, the terminal may select one randomly or according to a predefined procedure (for instance, starting with the lowest channel, etc.).

Once the radio access channel has been selected, the terminal begins the MSDU assembly process in step 506 by consulting the transmission rate indicator from step 505 associated with the selected radio access channel. This information is used modulate the data packet into the appropriate format for the radio access channel and to compute the required Duration field of the packet header. At this point the MSDU has been assembled from the data packet in step 506 and is transmitted on the selected radio access channel by transmitter 507 at the rate indicated by the transmission rate indicator from step 505. The MSDU assembly process occurs on the scale of nanoseconds, and thus does not unduly disturb the MAC-layer timing requirements, which occur on the order of microseconds.

If the transmitted packet requires a positive acknowledgement (ACK), the transmitted packet may remain in the TxQ 502 until the ACK is received with step 510. Otherwise the transmitted packet is dropped from the TxQ 502 and the next packet from the MAC Buffer 501 enters. By gating entry to the TxQ 502 in this fashion, the possibility that packets may arrive at the sender out of sequence is minimized or eliminated. If an anticipated ACK is not received, after a standards-defined ACK-timeout period appropriate to the radio access technology in use on the radio access channel that carried the packet transmission, the packet may be retransmitted on the next radio access channel who's CCA indicates a clear channel. This channel may employ a completely different radio access technology and be in a different radio frequency band than the previous transmission. Alternatively, it may be on the same radio frequency band using the same radio access technology. One advantage of using a different radio frequency with a different radio access technology is an attempt to eliminate the problem that prevented the previous transmission from being properly acknowledged.

The transmission mode in the RTS/CTS case is described below. Information 500 is received at the MAC buffer 501. A packet is passed from the MAC Buffer 501 to the TxQ 502. The channel selection process occurs in step 503 and the first radio access channel to report a clear channel may be selected for transmission of an RTS packet. With the parameters associated with the selected radio access channel, the station may assemble an RTS MSDU for transmission in step 506, which contains the correct Duration field information. Since the Duration information is determined by the radio access channel, the pending data MSDU may be sent on the same radio access channel as the RTS MSDU. Once the station has transmitted the RTS MSDU by transmitter 507, it may then (shortly thereafter or immediately) assemble a data packet MSDU using the channel parameters associated with the selected radio access channel. Alternatively, it may wait until a CTS response has been received.

Once the station receives the corresponding CTS in step 510, it may transmit the data MSDU on the same radio access channel. Should the station not receive a CTS within a standards-defined CTS timeout period, it may discard the assembled data MSDU and again enter the channel selection phase for the retransmission of the RTS packet. This retransmitted RTS MSDU may be sent on a different radio access channel than the original RTS MSDU, however all data MSDUs are sent on the same radio access channel as their associated RTS MSDUs. Alternatively, MSDUs may be sent on a different radio access channel than the RTS MDSUs as described above.

Assemble Before Selection

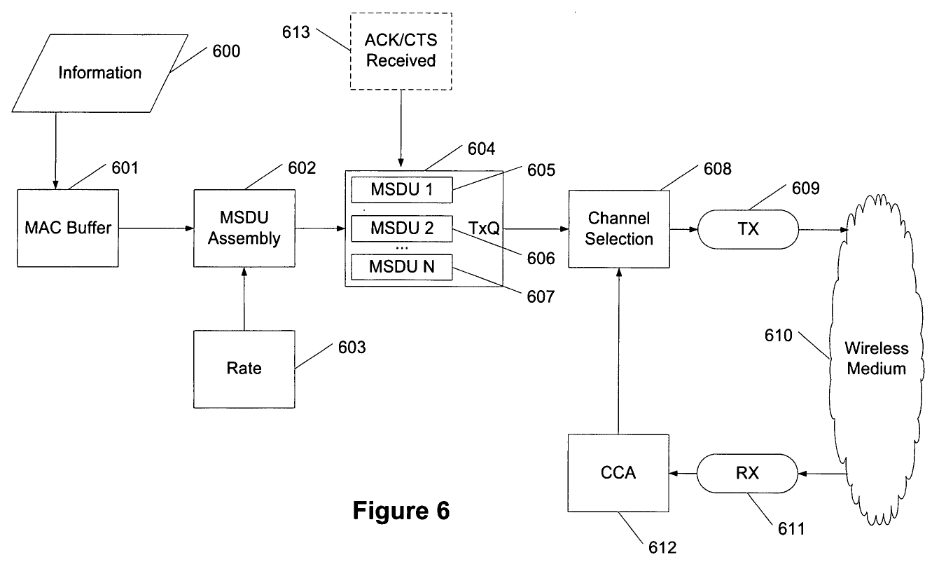

FIG. 6 shows another system for practicing aspects of the present invention. A difference between the system of FIG. 5 and the system of FIG. 6 is the order of the channel selection process and the creation of the MSDUs.

FIG. 5 shows an implementation of the invention that performs MSDU assembly 506 after channel selection 503 while FIG. 6 shows an implementation that performs MSDU assembly 602 before channel selection 608. The performance impact of the system of FIG. 5 is that a small time lag is introduced when CCA 504 indicates a clear channel and when the packet is ready to be transmitted. This time lag corresponds to the processing time required to assemble the MSDU. Since this is on the order of nanoseconds and the transmission timeslots are on the order of microseconds, this delay is not considered to significantly impact overall performance. The latter case prepares the MSDUs before channel selection and, therefore, can send them immediately after a CCA 612 indicates a clear channel. However, because the radio access channel is not yet known at time of MSDU assembly, the station is forced to generate multiple MSDUs in step 602, each corresponding to one of the candidate radio access channels N. This procedure introduces an additional processing and storage burden on the station. As processing power and semiconductor capacity increases, the performance impacts of both methods (of FIG. 5 and FIG. 6) become negligible.

The assembly before selection implementation of the invention as shown in FIG. 6 is similar to the above description with the major distinction being the creation of multiple MSDUs, each corresponding to the appropriate rate and modulation parameters for each candidate radio interface. Information to be transmitted 600 is received at MAC buffer 601. Next, in step 602, MSDU packets are created for all N channels from the data packets from MAC buffer 601. Rate information 603 and modulation schemes associated with all of the candidate radio access channels are used to create the MSDU packets.

MSDU packets from MSDU assembly 602 are received in transmit queue TxQ 604. Here. MSDU packets 1-N 605-607 (for the N channel) await the outcome of CCA 612 for a specified channel. Once the radio access channel has been selected from the channel selection 608, the TxQ 604 delivers the associated MSDU to the transmitter 609 for transmission over wireless medium 610. Receiver 611 provides information to CCA 612, which then provides a clear channel assessment to channel selection 608.

Similar to that described above, the system may prevent subsequent transmissions until an ACK response is received. The acknowledgement/request to resend is shown in step 613 forwarding an instruction to the TxQ 604 to send a new packet or send another MSDU relating to the current packet on another channel.

A similar process applies to the RTS/CTS method of delivery as well. In this case, multiple RTS MSDUs are assembled in the MSDU assembly process 602, each containing an appropriate duration field calculated for each of the candidate radio access channels. The channel selection process terminates and the RTS MSDU is transmitted on the selected radio access channel and the station prepares a data MSDU with the parameters associated the selected radio access interface. Once the station receives the corresponding CTS, the data MSDU is transmitted on the same radio access interface. If no CTS is received prior to a standards-defined CTS timeout period and signal provided in step 613, the data MSDU is discarded and the station reenters the RTS MSDU assembly phase. As in the selection before assembly case, all data MSDUs are sent on the same radio access channel as their associated RTS MSDUs. Alternatively, the data MSDUs may be sent on a different radio access channel than the channel used to transmit the associated RTS MSDU.

Assemble Before Selection Using Available Channels

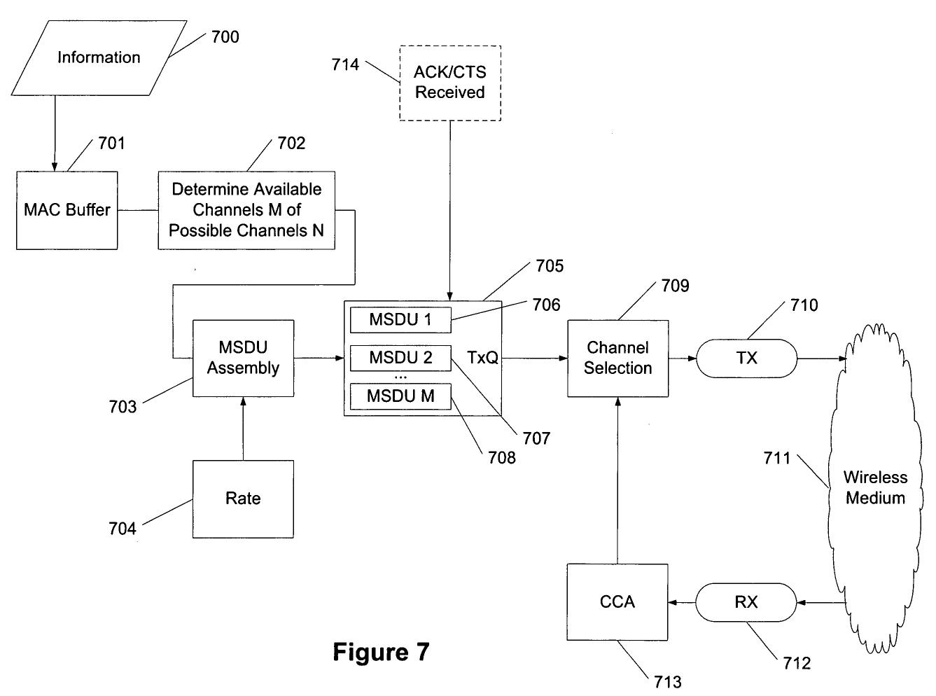

In FIG. 7, the system appreciates that, while N possible channels may be available, only a subset M may actually be at any given time. For instance, a transmitting station as shown in FIG. 7 may be capable of transmitting on all channels of 802.11a, 802.11b, and 802.11g. However, only the channels associated with 802.11a and 802.11b may actually be available. Accordingly, the system of FIG. 7 limits the generation of MSDUs to the actually available channels M as opposed the theoretically possible channels N.

Information 700 to be transmitted is received at MAC buffer 701. In step 702, the system determines which channels M are available of all channels N. Step 702 may include receiving channel information from receiver 712 (and possibly rate monitor 704 and CCA 713), may include looking up in a table which channels are available based on location or capabilities of a receiving station, or may include using past history of which channels have been used at a location or with another station. These approaches may be combined as well.

In step 703, the MSDUs are assembled for channels 1-M based on rate information 704. TxQ 705 holds MSDUs 1-M 706-708 for the various available channels. Once a channel is selected in step 709, based on CCA 713, the MSDU related to the selected channel is transmitted by transmitter 710 into wireless medium 711. A response back may be received by receiver 712. The output of receiver 713 may be used for the clear channel assessment 713. Also, the output of receiver 713 may be used to determine what rates are available in step 704. Finally, receiver 712 provides the ACK or CTS signals used in step 714 to alert TxQ 705 to continue.

CCA 504, 612, and 713 may only provide a single clear channel to may include a storage that stores the status of multiple channels. For instance, one may scan the various channels to determine whether they are clear or not and store that information in a table. The table may be provided to channel selection 506, 608, and 709. Alternatively, the table may be stored in a shared memory so that channel selection 506, 608, and 709 can access the table directly.

Aspects of the present invention include the processes described above being stored on a computer-readable medium in the form of a computer-implemented program. The medium may take various forms as known in the art including static memory, dynamic memory, portable and fixed.

The present invention has been described in terms of preferred and exemplary embodiments thereof. Numerous other embodiments, modifications and variations within the scope and spirit of the appended claims will occur to persons of ordinary skill in the art from a review of this disclosure.

I claim:

1. A method for transmitting information comprising the steps of:
determining which channel of a plurality of channels is clear;
forming a packet for transmitting on said channel; and
transmitting said packet on said channel.

2. The method according to claim 1, wherein said forming step forms an MSDU.

3. The method according to claim 1, further comprising the step of:
storing data to be transmitted in a transmit queue prior to said determining step.

4. The method according to claim 1, further comprising the steps of:
receiving information from a wireless medium;
performing a clear channel assessment of channels in said wireless medium;
wherein said determining step is performed based on an output of said clear channel assessment.

5. The method according to claim 4, further comprising the step of:
determining a rate of an available channel, wherein said determined rate is used in said forming step.

6. A method for transmitting information comprising the steps of:
forming packets for transmitting on each of a plurality of channels;
determining which channel of said plurality of channels is clear; and
transmitting said packet on said channel.

7. The method according to claim 6, wherein said forming step forms MSDUs.

8. The method according to claim 6, further comprising the step of:
storing said formed packets in a transmit queue prior to said determining step.

9. The method according to claim 6, further comprising the steps of:
receiving information from a wireless medium;
performing a clear channel assessment of channels in said wireless medium;
wherein said determining step is performed based on an output of said clear channel assessment.

10. The method according to claim 9, further comprising the step of: determining a rate of an available channel, wherein said determined rate is used in said forming step.

11. A method for transmitting information comprising the steps of:
determining which channels are available for use of all possible channels;
forming packets for transmitting on each of a plurality of channels;
determining which channel of said plurality of channels is clear; and
transmitting said packet on said channel.

12. The method according to claim 11, wherein said forming step forms MSDUs.

13. The method according to claim 11, further comprising the step of:
storing said formed packets in a transmit queue prior to said determining step.

14. The method according to claim 11, further comprising the steps of:
receiving information from a wireless medium;
performing a clear channel assessment of channels in said wireless medium;
wherein said determining step is performed based on an output of said clear channel assessment.

15. The method according to claim 14, further comprising the step of:
determining a rate of an available channel, wherein said determined rate is used in said forming step.

16. A method of performing clear channel assessment comprising the steps of:
monitoring channels;
determining if a first channel is clear and storing a result of whether said first channel is clear;
determining if a second channel is clear and storing a result of whether said second channel is clear;
transmitting on one of said clear channels.

17. The method according to claim 16, further comprising the step of:
storing said results in a table.

18. The method according to claim 17, wherein said table is sent to a channel selection module.

19. The method according to claim 17, wherein said table is stored in a common memory accessible by a channel selection module.

20. The method according to claim 16, further comprising the step of determining if a third channel is clear and storing the result of whether said third channel is clear.
